(19) United States
(12) Patent Application Publication
(10) Pub. No.: US 2024/0288339 A1
(43) Pub. Date: Aug. 29, 2024

(54) TESTING SYSTEM WITH ACOUSTIC NOISE REPLICATION THROUGH HYBRID SIMULATION

(71) Applicant: ILLINOIS TOOL WORKS INC., Glenview, IL (US)

(72) Inventor: Byron John Saari, Minneapolis, MN (US)

(21) Appl. No.: 18/583,265

(22) Filed: Feb. 21, 2024

Related U.S. Application Data
(60) Provisional application No. 63/448,177, filed on Feb. 24, 2023.

(51) Int. Cl. G01M 17/04

(52) U.S. Cl. CPC G01M 17/04

(57) ABSTRACT

A system and method for use with a testing machine having an actuator for applying loads or displacements to a test specimen, the system and method comprising a sensor operably coupled to the test specimen to sense motion or force and provide a sensor output signal. A signal transformation processing circuit coupled to receive the sensor output signal and configured to provide an output signal related to an audible and/or inaudible acoustic domain for test specimen and virtual components coupled to the test specimen. An output device coupled to receive the output signal related to the audible and/or inaudible acoustic domain and render information related to vibrations made by the test specimen and the virtual components coupled to the test specimen.

### CROSS-REFERENCE TO RELATED APPLICATION(S)

The present application is based on and claims the benefit of U.S. provisional patent application Ser. No. 63/448,177, filed on Feb. 24, 2023, the content of which is hereby incorporated by reference in its entirety.

### BACKGROUND

The discussion below is merely provided for general background information and is not intended to be used as an aid in determining the scope of the claimed subject matter.

In the field of vehicle testing there exists a sub-field referred to as Noise, Vibration, and Harshness (NVH). NVH the study of undesirable disturbances to the vehicle occupants in the forms of mechanical vibrations, acoustic noises and harsh impacts. A source of these noises can be generated from the road, the surrounding airflow, the engine, motor mounts and the shock absorber as well as other sources. In the case of the shock absorber (aka damper), by way of example, the acoustic noises can be sub-divided into acoustic noises directly from the shock such as squeaks due to friction or noises often referred to as “swish” which is often from oil flow within the damper. Another phenomenon of noise generation from the damper is a structure born noise which begins as a mechanical vibration from within the shock body itself. The structural vibrations then radiate from the damper body into the damper rod and then towards the upper shock absorber mount. In the vicinity of (or possibly some distance away) coupling between the damper rod and the structural body of the chassis, this mechanical vibration then transforms into acoustic noise.

By way of example, in the field of damper NVH testing, the air borne noises emitted directly from the shock absorber are well understood and easily replicated and identified in a damper load frame through laboratory component testing. The test consists of measuring the acoustic noise with a microphone and exercising the damper body with a batch of displacement wave forms which are known to highlight the acoustic noise emissions. However, in the field of NVH damper testing, the structure born noise paths often referred as “chuckle” are much more difficult to replicate and identify in the laboratory on component test load frames. There are many reasons why this is the case. A few of the primary reasons are that the load frame introduces disturbances which pollutes the measurements. Also, the typical damper test measurements are lower frequency measurements (<50 Hz) and for this special NVH testing, higher frequency measurements are required since the chuckle frequency content is higher in frequency (>100 Hz). Yet, another reason is that the true impendence of the surrounding structure which is coupled to the damper rod are not sufficiently replicated in the load frame mockup. Also, the measured data from a vibration test (acceleration and force) for purposes of, for example, fatigue testing of the damper are not directly representative of the acoustic phenomena that is desired. More specifically the desire is to identify the source and presence of an acoustic noise, commonly audible, but could in some situations be inaudible, where the fatigue testing and measurements are not directed to this phenomena.

A testing machine that can replicate this phenomenon of acoustic noise, such as but not limited to “chuckle”, from test specimens and components coupled to the test specimen for purposes of subjective investigation and/or quantitative analysis, the noise of which could audible and/or inaudible, would be desirable.

### SUMMARY

This Summary is provided to introduce some concepts in a simplified form that are further described below in the Detailed Description. This Summary is not intended to identify key features, essential features or all features of the invention. In addition, the description herein provided and the claimed subject matter should not be interpreted as being directed to addressing any of the shortcomings discussed in the Background.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

A system and method for use with a testing machine having an actuator for applying loads or displacements to a test specimen, the system and method comprising a sensor operably coupled to the test specimen to sense motion or force and provide a sensor output signal. A signal transformation processing circuit coupled to receive the sensor output signal and configured to provide an output signal related to an audible and/or inaudible acoustic domain for test specimen and virtual components coupled to the test specimen. An output device coupled to receive the output signal related to the audible and/or inaudible acoustic domain and render information related to vibrations made by the test specimen and the virtual components coupled to the test specimen.

Another aspect is a method where obtaining the signal transformation processing relationship may include: obtaining a finite element analysis model of the test specimen and the components coupled to the test specimen, and performing harmonic analysis upon the finite element analysis model to obtain the signal transformation processing relationship. Obtaining the signal transformation processing relationship may include: obtaining a finite element analysis model of the test specimen and the components coupled to the test specimen, and perform virtual transfer path analysis upon the finite element analysis model to obtain the signal transformation processing relationship. Obtaining the signal transformation processing relationship may also include: construct the test specimen and the components coupled to the test specimen, move the test specimen and/or apply forces to the test specimen, measure vibrations in the test specimen and/or the components coupled to the test specimen, and perform transfer path analysis using the measured vibrations to obtain the signal transformation processing relationship. Implementations of the described techniques may include hardware, a method or process, or computer software on a computer-accessible medium.

Another aspect is a testing system that includes a base, at least a pair of columns joined to the base and a crosshead joined to the columns at a location spaced apart from the bas. At least a pair of specimen holders are provided and include a first specimen holder supported by the crosshead and faces the base, and a second specimen holder supported by the base, the base being that portion joined to each of the columns closest to the crosshead. An actuator is connected in series between one of the specimen holders and the corresponding base or crosshead. The system also includes a sensor operably coupled to a test specimen to sense motion and/or force and provide a sensor output signal. A signal transformation processing circuit is coupled to receive the sensor output signal and configured to provide an output signal related to an audible and/or inaudible acoustic domain for test specimen and virtual components coupled to the test specimen. An output device is coupled to receive the output signal related to the audible and/or inaudible acoustic domain and render information related to vibrations made by the test specimen and the virtual components coupled to the test specimen. Other embodiments of this aspect include corresponding computer systems, apparatus, and computer programs recorded on one or more computer storage devices, each configured to perform the actions of the methods.

Implementations of the foregoing aspects may include one or more of the following features. The output device may include a speaker so as to provide generally subjective noise to the user, or in addition or in the alternative, the output device may include a module to visually render the output signal. As appreciated by those skilled in the art the signal transformation processing circuit may include analog circuitry and/or a processor coupled to memory configured to store values indicative of the sensor output signal and instructions configured to process the stored values and generate the output signal related to the acoustic domain for test specimen and virtual components coupled to the test specimen. The processor and instructions may include a digital filter. The output signal can be generated in substantially real time with the sensor output signal, or not in real time with respect to receipt of the sensor output signal. Implementations of the described techniques may include hardware, a method or process, or computer software on a computer-accessible medium.

### BRIEF DESCRIPTION OF THE DRAWINGS

FIG. 1 is a side elevational view of a testing machine.

FIG. 2 is a schematic illustration of a process control loop for controlling operation of the testing machine.

FIG. 3 is a block diagram depicting certain components of a computing device.

FIG. 4 is a block diagram illustrating processing of sensor signal(s) from the testing machine.

### DETAILED DESCRIPTION

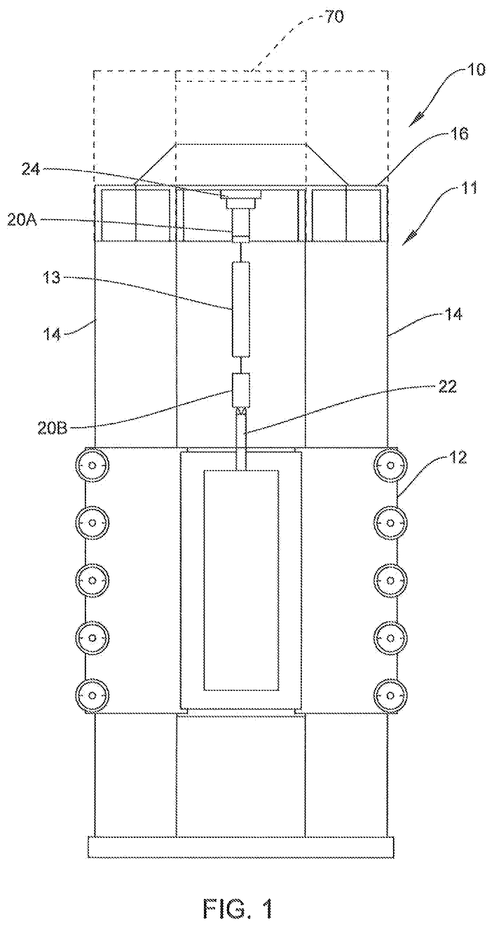

A schematic view of an exemplary testing machine 10 for applying forces or motions to a test specimen 13 (such as but not limited to a damper, shock, motor mount, etc.) is illustrated in FIG. 1. The testing machine includes a frame 11 having a base 12, a pair of columns 14 that extend upwardly from the base 12, and a crosshead 16 joined two of the columns 14 at a location spaced apart from the base 12. At least a pair of specimen holders, 20A, 20B, are provided. A first specimen holder 20A is supported by the crosshead 16 and extends toward the base 12. A second specimen holder 20B is supported by the base 12 and extends toward the crosshead 16. It should be noted, the base 12 is that portion of the testing machine 10 that is joined to each of the columns 14 closest to the crosshead 16.

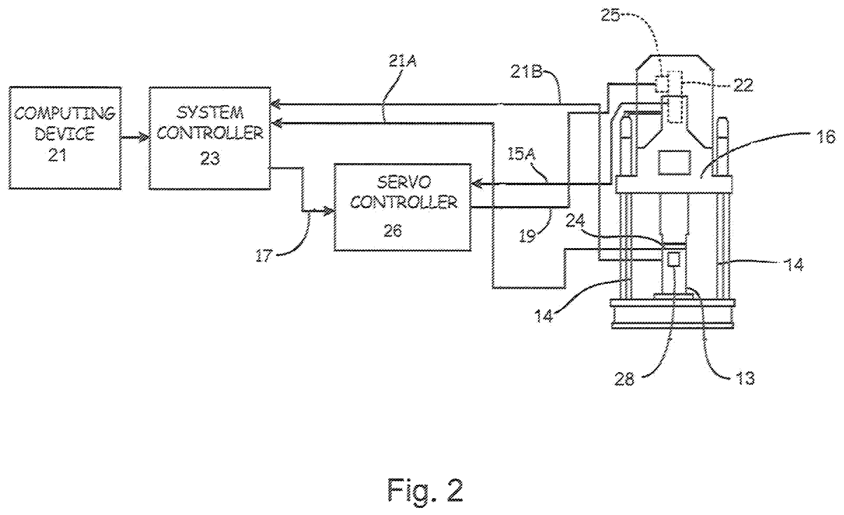

An actuator 22 is connected in series between one of these specimen holders 20A, 20B and the corresponding base 12 or crosshead 16. In the embodiment illustrated in FIG. 1, the first specimen holder 20A is joined to a force transducer 24 that is supported by the crosshead 16, while the second specimen holder 20B is coupled to the actuator 22 in the base 12. It should be noted in another embodiment illustrated in FIG. 2, the actuator 22 is located in the crosshead 16 whereas the force transducer 24 would then be joined to the base 12.

A control system described below controls operation of the actuator 22 based on a desired test profile to be applied to the test specimen 13. Desired forces and/or motions are applied to the test specimen 13 while feedback can be provided from a suitable sensor, for example, the force transducer 24 and/or a motion sensor such as a displacement sensor, velocity sensor, or an accelerometer 28 herein illustrated. As well understood by those skilled in the art, any of the forgoing motion sensors can be used with suitable processing to obtain the desired parameter indicative of motion, typically, acceleration but this should not be considered limiting. In the embodiment illustrated, the accelerometer 28 is coupled to an end of the test specimen 13 commonly as a matter of convenience although such placement or location should not be considered limiting.

The actuator 22 is typically an electromagnetic linear actuator in that the actuator 22 should be capable of motions and applied forces with high fidelity. One suitable actuator is described in US Published Patent Application 20210108998, Ser. No. 17/069,498, filed Oct. 13, 2020, entitled “ELECTRIC ACUATOR” and incorporated herein in its entirety by reference, although the specific construction should not be considered needed all applications. Although an electric actuator is well suited for the testing herein described, servo hydraulic actuators may be suitable depending on the specimen under test and the acoustic information desired, and hence, may also be used if desired.

It is further desired that the load frame 11 not hamper the acoustic information to be obtained and therefore should be sufficiently rigid so as not to contribute or dampen the desired acoustic information to be obtained. US Published patent application 20210215587, Ser. No. 17/148,267, filed Jan. 13, 2021, entitled “TESTING SYSTEM WITH COLUMN BRACE”, incorporated herein by reference in its entirety, describes additional bracing for the testing machine to improve stiffness and can be used if desired.

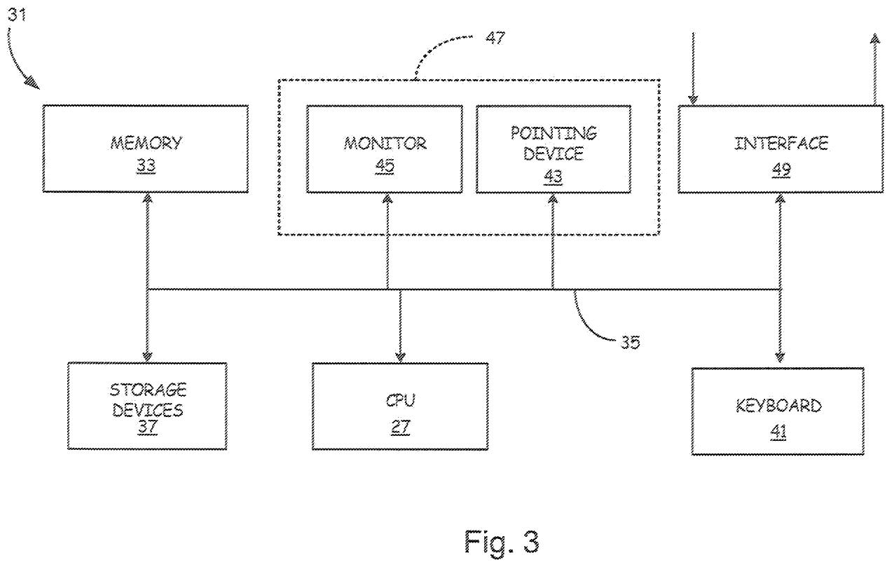

FIG. 3 illustrates a control system for the testing machine 10 and generally includes a computing device 21, a system controller 23 and a servo-controller 26. The computing device 21 allows a user to interact and/or control the test machine 10, while the system controller 23 controls the servo-controller 26 based on the testing to be performed. The servo-controller 26 provides an actuator command signal 19 to a controlled device 25 (e.g. servo valve, servo-drive, power controller) to operate the actuator 22 (in this embodiment located in the crosshead 16), which in turn, excites the test specimen 13. It should be noted the controller 26 and controlled device 25 are of designs suitable for controlling the type of actuator employed. Suitable feedback 15A can be provided from the actuator 22 to the controller 26 or from other sensors. One or more remote transducers on the test specimen 13, and/or the actuator 22, and/or the specimen supports 20A, 20B, and/or the support frame 11, etc. such as displacement sensors, strain gauges, accelerometers, load cells, thermometers, microphones, cameras or the like, provide a measured or actual response 21B. In the exemplary embodiment, the load cell 24 also provides a response 21A. The system controller 23 can also receive actual response 21B as feedback in a response to a drive 17 as input to the servo controller 26. In the illustration of FIG. 2, signal 17 is a reference signal, signal 19 is a manipulated variable (command to actuated device) and signal 15A is a feedback variable. Although illustrated in FIG. 2 for the single channel case, multiple channel embodiments with signal 15A comprising N feedback components and the signal 19 comprising M manipulated variable components could possibly be present and considered another embodiment of the present invention. Typically, types of loads that can be applied or imparted to the test specimen 13 include tension, compression and/or torsion in one or more degrees of freedom applied separately or at the same time, commonly through separate actuators. The test specimen 13 can also or alternatively be subjected to controlled displacements in one or more degrees of freedom applied separately or at the same time.

The computing device 21, system controller 23 and controller 26 can each be implemented on a digital and/or analog computer or circuitry. FIG. 3 and the related discussion provide a brief, general description of a suitable computing environment in which the computing device 21, system controller 23 and controller 26 may each be implemented. The computing device 21, system controller 23 and controller 26, at least in part, can be implemented in the general context of computer-executable instructions, such as program modules, being executed by a computer 31. Generally, program modules include routine programs, objects, components, data structures, etc., which perform particular tasks or implement particular abstract data types. Those skilled in the art can implement the description below and/or block diagrams to computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 31 illustrated in FIG. 3 comprises a conventional computer having a central processing unit (CPU) 27, memory 33 and a system bus 35, which couples various system components, including memory 33 to the CPU 27. System bus 35 may be any of several types of bus structures including a memory bus or a memory controller, a peripheral bus, and a local bus using any of a variety of bus architectures. The memory 33 includes read only memory (ROM) and random access memory (RAM). The central processing unit or processor 27 is coupled to memory and configured to store values indicative of the sensor output signal and instructions configured to process the stored values and generate the output signal related to the acoustic domain for test specimen and virtual components coupled to the test specimen. A basic input/output (BIOS) containing the basic routine that helps to transfer information between elements within the computer 31, such as during start-up, is stored in ROM. Storage devices 37, such as a hard disk, a floppy disk drive, an optical disk drive, etc., are coupled to the system bus 35 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 33 from at least one of the storage devices 37 with or without accompanying data.

Input devices such as a keyboard 41 and pointing device (mouse) 43, or the like, allow the user to provide commands to the computer 31. A monitor 45 or other type of output device is further connected to the system bus 35 via a suitable interface and provides feedback to the user. If the monitor 45 is a touch screen, the pointing device 43 can be incorporated therewith. The monitor 45 and typically an input pointing device 43 such as mouse together with corresponding software drivers form a graphical user interface (GUI) 47 for computer 31 that is particularly useful with aspects described below.

Interfaces 49 on each of the computing device 9 and system controller 23 allow communication between the computing device 9 and the system controller 23. Likewise, interfaces 49 on each of the system controller 23 and the controller 26 allow communication between the system controller 23 and the controller 26. Interface 49 also represents circuitry used to send signals 19 or receive signals 15 as described above as well as other parameters of the physical system such as the status of locks, doors, indicators, whether power is applied, etc. Commonly, such circuitry comprises digital-to-analog (D/A) and analog-to-digital (A/D) converters as is well known in the art. The controller 26 can also comprise an analog controller with or without digital supervision as is well known. Functions of computing device 21, system controller 23 and controller 26 can be combined into one computer system. In another computing environment, controller 26 is a single board computer operable on a network bus of another computer, which could be controller 23 or another supervisory computer. The schematic diagram of FIG. 3 is intended to generally represent a computer for these and other suitable computing environments.

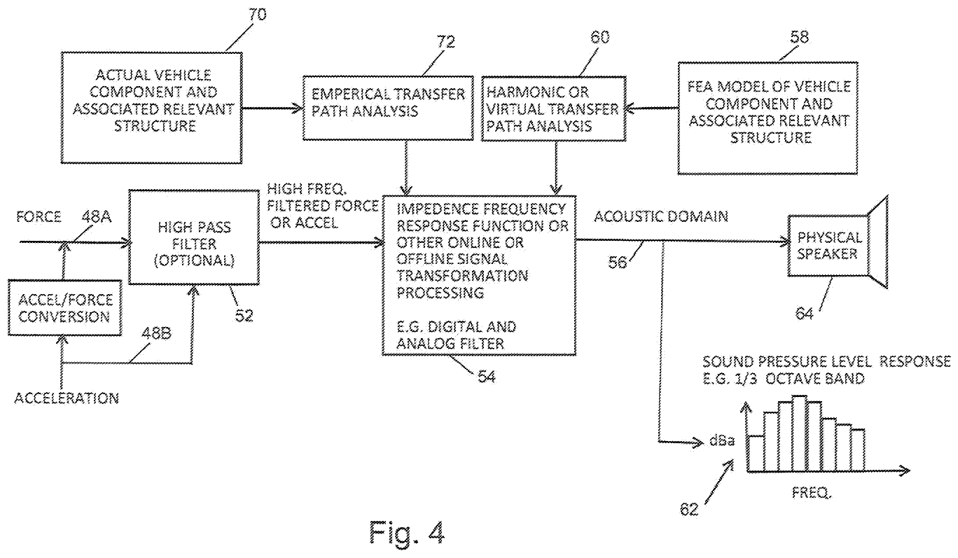

FIG. 4 is a block diagram illustrating processing of sensor signal(s) 48A, 48B from the testing machine 10 applying loads or displacements to the test specimen 13 to render audible and/or inaudible acoustic domain and render information related to vibrations made by the test specimen 13 and the virtual components (not shown) coupled to the test specimen 13. Generally, a sensor such as the load cell 24 or accelerometer 18 herein depicted by way of example (although other forms of sensors such as velocity, displacement, etc. can be used as indicated above) provides a sensor output signal indicative of force 48A or motion 48B. As illustrated, sensed force 48A can be used as the process signal. Alternatively, if motion 48B, such as sensed by the accelerometer 18, is provided it can be processed directly, or converted to a corresponding force through an acceleration/force conversion module 50 using, for example a model based on equations between force and acceleration, or an empirically based lookup table. Since higher frequency components are generally most desired, a suitable high pass filter 52 can be used to remove any low frequency components that may not be desired from signals 48A and/or 48B.

The signal(s) 48A, 48B from the sensor is provided to a signal transformation processing circuit or module 54 that has been configured to provide an output signal 56 related to audible and/or inaudible acoustic domain for test specimen and virtual components coupled to the test specimen, but not present on the testing machine 10. For instance in a damper used on vehicles, the flexible components present in the upper shock mount vicinity can act like an acoustic speaker driven by the damper rods forcing function. An aspect of the invention is to address the mechanical impedance mismatch of the test specimen 13 and its virtual components such as the upper shock mount and surround flexible members, as well as transforming these vibrations directly into the resulting acoustic noise (Sound Pressures) which is expected in the real vehicle body. The mechanical vibrational response of the upper shock mount and the surrounding structure can be very complex in its mechanical impedance characteristics; however, these coupled components which can contribute significantly to the generated acoustic noise can be modeled as illustrated at 58, for example with current state of the art in FEA (Finite Element Analysis). In one embodiment, the impedance can be modeled and characterized for instance with the signal transformation processing circuit or module 54 generating convolution information for example embodied as a Frequency Response Function. This can be accomplished with FEA harmonic response analysis 60 of the FEA model 58, and subsequently the FEA model 58 can be represented by a reduced order state space model between finite input and output locations, used by the signal transformation processing circuit or module 54.

Two exemplary methods to transform the specimen 13 response (for example, a damper rod response or the physical damper rod along with the physical elastomeric upper shock mount included in the physical specimen setup) into a resulting noise emission from the virtual speaker (coupled virtual components). One is to use the force measured at the specimen 13 (e.g. damper rod, or the physical damper rod along with the physical elastomeric upper shock mount included in the physical specimen setup, as the input excitation into the virtual components and the other is to use the measured damper rod acceleration, or the physical damper rod along with the physical elastomeric upper shock mount included in the physical specimen setup, as the input excitation into the virtual components. The first case (force input) may be more direct and straight forward. In the case of a damper, but can be present with other specimens, the upper shock mount region normally includes an elastic isolator (where the elastomeric isolator can be represented as part of the virtual representation or it can be included as part of the physical specimen) mounted to a metallic body structure. Through FEA analysis, the resulting mechanical motion of this upper mount region, from an input forcing function, can be generated through a harmonic modal analysis.

As far as input into the FEA model, generally, force excitation is introduced at the actuator location in the FEA model. The displacement, acceleration, and force output at various locations is then measured which helps determine the transmissibility. Often the dynamic stiffness of a ‘standard’ or actual specimen is measured. Sometimes acceleration compensation is required. This can all be modeled with a harmonic FEA analysis. Although typically harmonic analysis is used to predict the response for different discrete sinusoidal input excitations, this frequency-by-frequency response can be used more generically to study the response of the system for any input, sinusoidal or non-sinusoidal. This sinusoidal discrete frequency data is what information is needed to create a frequency domain transfer function, or alternatively perhaps some other form of transformation as indicated herein.

This harmonic modal analysis can generate a frequency response function of the motion (displacement or acceleration) output for a force input. This frequency response function can use fitting techniques to approximate a continuous transfer function of some reduced order of reasonable size for the frequencies of interest. This continuous transfer function can be transformed into an equivalent discrete transfer function and then be realized as a digital filter which can be applied to the signal in real-time, i.e. as the specimen is actuated by the actuator 22. This digital filter will then represent the forced response (dynamic response) of the virtual components that are acting as a virtual speaker.

The force 48B measured from the high bandwidth force transducer 24 on the physical load frame 11 can be sent provided to this model of the virtual speaker (thru a convolution with the digital filter) in the signal transformation processing circuit or module 54 and then the resulting output signal 56 can be sent to a physical speaker 64, if desired, so that any humans will hear the simulated noise emitted from the vehicle body in real-time. Preferably, the physical speaker 64 should be of high fidelity so as not to introduce its own dynamics into the simulation. This will provide a real-time subjective evaluation of the acoustic behavior of the physical specimen 13 in the load frame 11 coupled with any choice of virtual components such as an upper shock mount assembly from any particular vehicle platform used in the FEA model 58. As such, the testing machine 10 with the signal processing herein described will assist in identifying what particular load or displacement profiles such as from a road generate the unwanted noise as well as assist in identifying the underlying source of the noise from within the specimen physical and/or virtual components.

In the case of a damper, by way of example, the upper shock mount and body structure impedance can greatly influence the existence or non-existence of acoustic, i.e. “chuckle”, noise. For instance, the physical specimen, i.e. the damper or damper and upper mount, alone cannot determine the existence of a chuckle noise. Only a coupled system, i.e. the specimen such as the damper and upper shock mount and body structure impedance, herein virtually modeled, can accurately reproduce chuckle. And with this approach using a virtual representation, different upper coupled assemblies and/or with virtual coupled components with different physical or material characteristics can very quickly be evaluated with a real test specimen, such as the damper described by way of example.

It should be noted that the forces transmitted through the test specimen 13, for example a damper rod may be influenced to some extent by the coupling with the (virtual or physical) upper shock mount and surrounding (virtual) body structure. Note that some portion of the body structure could also be included in the physical specimen where practically realizable. The majority of the coupling behavior will be dependent on the most elastic member in the coupled system, typically an elastomer component. In the case of some test specimens, such as dampers, a majority of the acoustic signature is expected to be from the surrounding, virtual, metallic coupled flexible body members. As such, it could be advantageous that the real elastomeric component on the test specimen, or the virtual elastomeric member if modeled, should be match relatively close to the real elastic dynamic stiffness component present in the system being modeled; however, the virtual components acting as a speaker should still replicate the noises even if the dynamic stiffness is off by for example a factor of two or less.

Alternatively, or in addition, to sending the resulting output signal 56 from the signal transformation processing circuit or module 54 to the speaker 64, the output signal 56 can be provided to a sound processing module 62 to calculate the resulting pressure fluctuation (therefore sound pressure level) related to the output signal 56. This estimated sound pressure level can then be used as a more objective test for the allowable emitted noise, the resulting data of which can be rendered to the user in any convenient hard copy or data format on a computer readable medium such as in a spreadsheet or table, and/or rendered to the user on a suitable monitor. For instance, these estimated sound pressure levels can be filtered with traditional weighting and converted into ⅓ octave bands. If desired, the user can configure pass/fail criteria that can be used, for example by assigning an overall dBa acceptable level or acceptable dBa levels of one or more selected octave bands, which can be processed by the sound processing module 62 and then rendered to the user. This description shows for example ⅓ octave bands since this is most often used by acoustic engineers, but time domain traces or power spectrums or other frequency domain representations can also be used.

It should be noted in yet another method to transform the measured acceleration into an acoustic noise, the inverse forced response of the test specimen is used in the simulation chain. In this method, the measured acceleration is first be filtered by the signal transformation processing module 54 as a digital filter representative of the inverse forced response and then multiplied by the virtual speakers' force response. And then the subsequent signal is played out to the physical speaker 64 or provided to sound processing module 62.

At this point it should be noted that the embodiments of the present invention are not limited to real-time processing, i.e. generation of output signal 56 in substantially real-time with loads and/or displacements of the test specimen 13 as provided by signals 48A and/or 48B. In other words, processing by signal transformation processing circuit or module 54 can be performed based on stored data indicative of signals 48A and/or 48B not in real-time but rather, for example, after the forces and displacements to the test specimen 13 have completed. Likewise, signal transformation processing circuit or module 54 need not process data so as to generate an output signal 56 that can generate acoustic noise in a manner perceived by a human, but rather generate additional information that is not necessarily perceptible to a human.

Finally, concepts herein presented should not be limited to FEA modeling and subsequent harmonic analysis. In particular, modeling and analysis can take other forms such as but not limited to Transfer Path Analysis. Transfer Path Analysis can be based on virtually modeled components or empirically based on measurements taken from actual components, the measured data being used to aid in creating the virtually modeled system or used to obtain the convolution information or relationship, e.g. FRF (Frequency Response Function) used by signal transformation processing circuit or module 54 or possibly some other transformation. In FIG. 4, processing module 60 can include Transfer Path Analysis of the FEA model. Alternatively, the actual test specimen and coupled components, herein by example, vehicle components are used at 70 and instrumented so as to obtain vibration measurements. Shakers or the like can be attached to the actual components if desired and actuated so as to obtain vibration measurements, commonly forces and or accelerations, or such measurements can be obtained from actual field data of the test specimen and coupled components. The vibration measurements are then empirically analyzed at 72 so as to obtain transfer functions (or some other transformation) for use in signal transformation processing circuit or module 54. Transfer Path Analysis is well known and described in a white paper “Transfer Path Analysis” by Siemens Product Lifecycle Management Software Inc., 2018, incorporated herein by reference.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

What is claimed is:

1. A system for use with a testing machine having an actuator for applying loads or displacements to a test specimen, the system comprising:
a sensor operably coupled to the test specimen to sense motion or force and provide a sensor output signal;
a signal transformation processing circuit coupled to receive the sensor output signal and configured to provide an output signal related to an audible and/or inaudible acoustic domain for test specimen and virtual components coupled to the test specimen; and
an output device coupled to receive the output signal related to the audible and/or inaudible acoustic domain and render information related to vibrations made by the test specimen and the virtual components coupled to the test specimen.

2. The system of claim 1 wherein the output device comprises a speaker.

3. The system of claim 1 wherein the output device comprises a module to visually render the output signal.

4. The system of claim 3 wherein the output device comprises a speaker.

5. The system of claim 1 wherein the signal transformation processing circuit comprises analog circuitry.

6. The system of claim 1 wherein the signal transformation processing circuit comprises a processor coupled to memory configured to store values indicative of the sensor output signal and instructions configured to process the stored values and generate the output signal related to the acoustic domain for test specimen and virtual components coupled to the test specimen.

7. The system of claim 6 wherein the processor and instructions comprise a digital filter.

8. The system of claim 7 wherein the output signal is generated in substantially real time with the sensor output signal.

9. The system of claim 6 wherein the output signal is generated based not in real time with respect to receipt of the sensor output signal.

10. A method of generating audible and inaudible information in an acoustic domain related to a test specimen and virtual components coupled to the test specimen, the method comprising:
obtaining a signal transformation processing relationship of a test specimen and components coupled to the test specimen, the signal transformation processing relationship relating motion or force of the test specimen to audible and/or inaudible vibrations generated by the test specimen and virtual components coupled to the test specimen due to motion or the test specimen and/or forces applied to the test specimen;
mounting the test specimen in a test machine having an actuator configured to move the test specimen and/or apply forces to the test specimen;
sense at least one of motion of the test specimen and/or force applied to the test specimen and obtain a sensor output signal;
apply the sensor output signal to the signal transformation processing relationship of a test specimen and components coupled to the test specimen;
obtain an output signal from the signal transformation processing relationship signal related to the acoustic domain for test specimen and virtual components coupled to the test specimen; and
apply the output signal to an output device and render information related to audible and/or inaudible vibrations made by the test specimen and the virtual components coupled to the test specimen.

11. The method of claim 10 wherein obtaining the signal transformation processing relationship comprises:
obtaining a finite element analysis model of the test specimen and the components coupled to the test specimen; and
perform harmonic analysis upon the finite element analysis model to obtain the signal transformation processing relationship.

12. The method of claim 10 wherein obtaining the signal transformation processing relationship comprises:
obtaining a finite element analysis model of the test specimen and the components coupled to the test specimen; and
perform virtual transfer path analysis upon the finite element analysis model to obtain the signal transformation processing relationship.

13. The method of claim 10 wherein obtaining the signal transformation processing relationship comprises:
construct the test specimen and the components coupled to the test specimen;
move the test specimen and/or apply forces to the test specimen;
measure vibrations in the test specimen and/or the components coupled to the test specimen; and
perform transfer path analysis using the measured vibrations to obtain the signal transformation processing relationship.

14. A testing system comprising:
a base;
at least a pair of columns joined to the base;
a crosshead joined to the columns at a location spaced apart from the base;
at least a pair of specimen holders, wherein a first specimen holder is supported by the crosshead and faces the base, and a second specimen holder is supported by the base, the base being that portion joined to each of the columns closest to the crosshead;
an actuator connected in series between one of the specimen holders and the corresponding base or crosshead;
a sensor operably coupled to a test specimen to sense motion or force and provide a sensor output signal;
a signal transformation processing circuit coupled to receive the sensor output signal and configured to provide an output signal related to an audible and/or inaudible acoustic domain for test specimen and virtual components coupled to the test specimen; and
an output device coupled to receive the output signal related to the audible and/or inaudible acoustic domain and render information related to vibrations made by the test specimen and the virtual components coupled to the test specimen.

15. The system of claim 14 wherein the output device comprises a speaker.

16. The system of claim 14 wherein the output device comprises a module to visually render the output signal.

17. The system of claim 16 wherein the output device comprises a speaker.

18. The system of claim 14 wherein the signal transformation processing circuit comprises analog circuitry.

19. The system of claim 14 wherein the signal transformation processing circuit comprises a processor coupled to memory configured to store values indicative of the sensor output signal and instructions configured to process the stored values and generate the output signal related to the acoustic domain for test specimen and virtual components coupled to the test specimen.

20. The system of claim 19 wherein the output signal is generated in substantially real time with the sensor output signal.
